(19) United States
(12) Patent Application Publication
(10) Pub. No.: US 2005/0069770 A1
(43) Pub. Date: Mar. 31, 2005

(54) Lithium ion battery with dissimilar polymer compositions in electrodes

(76) Inventors: Vesselin G. Manev, Flint, MI (US); Yee-Ho Chia, Troy, MI (US)

Correspondence Address: DELPHI TECHNOLOGIES, INC., M/C 480-410-202, PO BOX 5052, TROY, MI, 48007, US

(21) Appl. No.: 10/677,051

(22) Filed: Sep. 30, 2003

(51) Int. Cl. H01M 4/62

(52) U.S. Cl. 429/217

(57) ABSTRACT

A lithium polymer battery having a greater comonomer quantity in the polymer of the negative electrode than in the polymer of the positive electrode. The negative electrode polymer is a copolymer of a first primary monomer and 1-30 wt. % of a first comonomer, and the positive electrode is either a homopolymer of a second primary monomer or a copolymer of the second primary monomer and up to 25 wt. % of a second comonomer.

### TECHNICAL FIELD

This invention relates to lithium ion batteries, and in particular, the polymer composition of the positive and negative electrodes in the battery cells.

### BACKGROUND OF THE INVENTION

Lithium-ion cells and batteries are secondary (i.e., rechargeable) energy storage devices well known in the art. The lithium-ion cell, known also as a rocking chair type lithium battery, typically comprises a carbonaceous negative electrode that is capable of intercalating lithium-ions, a lithium-retentive positive electrode that is also capable of intercalating lithium-ions, and a separator impregnated with non-aqueous, lithium-ion-conducting electrolyte therebetween.

The negative carbon electrode comprises any of the various types of carbon (e.g., graphite, coke, mesophase carbon, carbon fiber, etc.) which are capable of reversibly storing lithium species, and which are bonded to an electrically conductive current collector (e.g., copper foil) by means of a suitable organic binder (e.g., polyvinylidene difluoride, PVDF). The negative electrode may contain, for example, 5-15 wt. % polymer material.

The positive electrode comprises such materials as transition metal chalcogenides that are bonded to an electrically conductive current collector (e.g., aluminum foil) by a suitable organic binder. The positive electrode may contain, for example, 6-18 wt. % polymer material. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable positive electrode materials include LiMnO₂, LiCoO₂ and LiNiO₂, their solid solutions and/or their combination with other metal oxides.

The electrolyte in such lithium-ion cells comprises a lithium salt dissolved in a non-aqueous solvent which may be (1) completely liquid, (2) an immobilized liquid, (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polycarbonates, polyfluorides, polyvinylidene fluorides and polyvinylidene fluoride based co-polymers, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into the pores of the positive and negative electrode and in a separator layer between the positive and negative electrode. The separator may be a porous polymer material such as polyethylene, polyfluoride, polypropylene or polyurethane, or may be glass material, for example, containing a small percentage of a polymeric material, or may be any other suitable ceramic or ceramic/polymer material.

Lithium-ion cells made from pure polymer electrolytes, or liquid electrolytes entrapped in a polymer matrix, are known in the art as “lithium-ion polymer” cells, and the electrolytes therefore are known as polymeric electrolytes. Lithium-polymer cells are often made by laminating thin films of the negative electrode, positive electrode and separator together wherein the separator layer is sandwiched between the negative electrode and positive electrode layers to form an individual cell, and a plurality of such cells are bundled together to form a higher energy/voltage battery.

In lithium ion polymer systems, the polyvinylidene fluorides (PVDF) homopolymer and PVDF-based copolymers are largely used as a polymer binder in the positive and negative electrodes of the lithium polymer battery. The PVDF homopolymers and copolymers offer an advantage over other polymer systems due to the ability of PVDF to absorb some electrolyte and become ionically conductive while preserving its good mechanical properties. With an increase in the amount of the comonomer in the PVDF-based copolymer, the ionic conductivity of the polymer increases, but the mechanical properties decrease. Because the same polymer is generally used to adhere the current collector to the electrodes, and to adhere the separator to the electrodes, the polymer selection is typically a trade-off between the mechanical properties and the ionic conductivity desirable for each cell component. Optimization of the mechanical properties and ionic conductivity is typically established by an equivalent change in the polymer compositions of both electrodes.

However, because the requirements for the polymer compositions of the positive and negative electrodes are significantly different, there is a need to develop a lithium cell using a polymer system that is compatible throughout the positive and negative electrodes and intervening separator, but that also meets the mechanical property and ionic conductivity requirements for the individual electrodes.

### SUMMARY OF THE INVENTION

A lithium polymer battery is provided having a greater comonomer quantity in the polymer of the negative electrode than in the polymer of the positive electrode. The dissimilar polymers and/or amounts of polymer components in the two electrodes allow the battery to be designed to account for the different mechanical, electronic and ionic conductivity requirements of the two electrodes, while maintaining compatibility of the polymeric matrix throughout the cell. In accordance with the present invention, the negative electrode polymer is a copolymer of a first primary monomer and 1-30 wt. % of a first comonomer, and the positive electrode is either a homopolymer of a second primary monomer or a copolymer of the second primary monomer and up to 25 wt. % of a second comonomer. Advantageously, the negative electrode comprises 3-15 wt. % comonomer and the positive electrode comprises 0-6 wt. % comonomer. In an exemplary embodiment of the present invention, the same primary monomer is used in each electrode, as well as in the separator layer between the electrodes to provide compatibility throughout the cell. In a further exemplary embodiment, PVDF is used in each electrode and the separator layer.

### BRIEF DESCRIPTION OF THE DRAWINGS

The present invention will now be described, by way of example, with reference to the accompanying drawings, in which:

FIG. 1 is a graph of the cell capacity as a function of the number of cycles in a calendar life test at 55° C. for a battery cell of the present invention having dissimilar polymer compositions for the negative and positive electrodes as compared to prior art battery cells having the same polymer composition for both electrodes;

FIG. 2 is a graph of the cell capacity retention at a charge-discharge rate of C/2 as a function of the number of cycles in a calendar life test at 55° C. for a battery cell of the present invention compared to a battery cell of the prior art; and

FIG. 3 is a graph of the relaxation voltage as a function of the number of cycles in a calendar life test at 55° C. for a battery cell of the present invention compared to a battery cell of the prior art.

### DETAILED DESCRIPTION

The present invention provides a lithium polymer battery in which the polymers in the negative electrode and positive electrode are dissimilar to thereby account for the different properties required for each electrode. The positive electrode material typically requires a low electrical conductivity and, to keep a good electronic contact between the particles during the cell life, a strong bounding property with a low swelling affect. In contrast, for a good formation of the solid electrolyte interface (SEI) layer on the negative electrode, a large ionic conductivity of the polymer and strong polymer swelling is highly beneficial. During the formation of the SEI layer on the negative electrode, the SEI layer composite further binds the negative electrode particles and strongly recovers the mechanical properties of the negative electrode. Thus, the optimal polymer composition for the two electrodes is different, such that any improvement in the performance of one of the electrodes by a change in the cell polymer composition may cause a negative affect on the performance of the other electrode. With this understanding, the present invention provides dissimilar polymer compositions for the two electrode that are designed to meet the separate requirements for each electrode, while also maintaining the overall polymer compatibility throughout the battery cell.

To this end, the negative electrode comprises a polymer (POLYneg) that is a copolymer of at least one primary monomer (MONneg) and 1-30 wt. % of a comonomer (COMMneg). Thus, the negative electrode comprises a polymer according to the formula:
COMMneg/(MONneg+COMMneg)=0.01−0.3
The positive electrode comprises a polymer (POLYpos) that is either a homopolymer of a primary monomer (MONpos) or a copolymer of a primary monomer (MONpos) and up to 25 wt. % of a comonomer (COMMpos). Thus, the positive electrode comprises a polymer according to the formula:
COMMpos/(MONpos+COMMpos)=0−0.25
If the result of the formula is 0, then the polymer contains no comonomer, and is therefore a homopolymer of the primary monomer. In accordance with the present invention, in a lithium polymer battery, the amount of comonomer in the negative electrode is greater than the amount of the comonomer in the positive electrode. In an exemplary embodiment of the present invention, the negative electrode comprises 3-15 wt. % of the comonomer and the positive electrode comprises 0-6 wt. % of the comonomer.

The positive and negative electrodes comprise at least one primary monomer, and the monomers, after polymerization, may each be selected from the group consisting of polyvinylidene fluoride, polyvinylidene chloride fluoride, polyvinylidene chloride, polyvinyl chloride, polyvinylchloride acetates, polyacrylonitriles, polyfluoroethylenes, polyfluoropropylenes, polyolefins, acrylic acid modified polyethylene, maleic acid modified polyethylene, acrylic acid modified polypropylene, maleic acid modified polypropylene, polyvinyl alcohols, polyglycols, polyacetates, polyesters, polyacrylates, polycarbonates, polyethylene oxides, polypropylene oxides, polyacrylic acid esters, cellulose acetate, cellulose butyrate, nylons, polyurethanes, polyterephthalates, and polystyrenes. Advantageously, the primary monomer in each of the negative and positive electrodes, after copolymerization or homopolymerization, is polyvinylidene fluoride (PVDF). More advantageously, the negative electrode contains a copolymer of PVDF and the positive electrode consists essentially of a PVDF homopolymer.

In an exemplary embodiment of the present invention, the same primary monomer may be used in each of the positive and negative electrodes, as well as in the separator between the electrodes or in the adhesive adhering the separator to both electrodes. As a result, a high degree of compatibility may be maintained throughout the cell, thereby providing good adherence between cell layers. Thus, in this exemplary embodiment, the primary monomer in each of the negative electrode and the positive electrode, and in the separator or in the adhesive adhering the separator to both electrodes, may be PVDF.

In accordance with the present invention, the dissimilarity between the polymer compositions of the electrodes is provided by the comonomer content. The negative electrode polymer contains a greater amount of comonomer than the positive electrode polymer. The higher comonomer content in the negative electrode contributes to a higher ionic conductivity, which is beneficial for good formation of the SEI layer. The decrease in mechanical properties that may occur with higher amounts of comonomer is compensated for by the binding contribution of the SEI layer. In contrast, in the positive electrode where no SEI layer forms, a lower ionic conductivity is not critical and strong mechanical binding properties are highly desirable, such that the lower comonomer content is advantageous. Thus, by using a higher comonomer content in the negative electrode than in the positive electrode, the separate needs of each electrode are met and the cell displays an optimal electrochemical performance.

The comonomer in the negative electrode and optionally in the positive electrode may, for example, be selected from the group of hexafluoropropylene (HFP) and chlorotrifluoroethylene (CTFE). More advantageously, the comonomer is HFP. Further, when the positive and/or negative electrode contains HFP as a comonomer, the primary monomer is advantageously PVDF. In an exemplary embodiment, the negative electrode comprises a copolymer of PVDF and HFP and the positive electrode comprises either a homopolymer of PVDF or a copolymer of PVDF and HFP. In a further exemplary embodiment, the negative electrode comprises a copolymer of PVDF and 3-15 wt. % HFP and the positive electrode comprises either a homopolymer of PVDF or a copolymer of PVDF and HFP in an amount up to 6 wt. %. Also advantageously, the separator layer between the electrodes comprises a copolymer of PVDF and a comonomer or the adhesive adhering the separator to both electrodes is a homopolymer or copolymer of PVDF and a comonomer.

### EXAMPLES

### Example 1

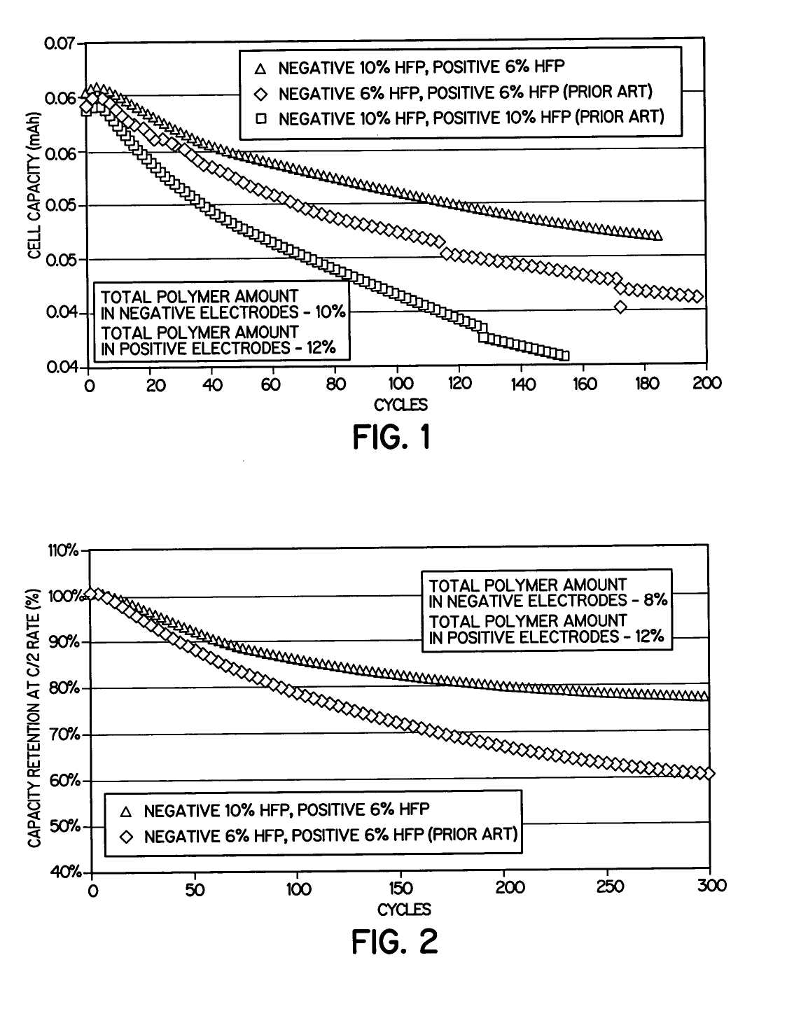

A negative carbon electrode was prepared in accordance with techniques well known in the art using a copolymer binder of PVDF and 10% HFP, supplied by Atofina under the brand name KYNAR FLEX® 2800. A transition metal chalcogenide positive electrode was prepared using a copolymer binder of PVDF and 6% HFP, supplied by Atofina under the brand name KYNAR POWERFLEX® LBG 151. The total amount of the polymer binder in the negative electrode composite was 10% and in the positive electrode was 12%. The electrodes were assembled in a battery cell and subjected to a cycle life test at 100% DOD (Depth-of-Discharge) and 55° C. The cell capacity fade during the cycle life test is depicted in FIG. 1 for the battery of the present invention. For comparison, a prior art battery cell was assembled in which both the positive and negative electrodes were prepared with the copolymer binder of PVDF and 6% HFP, supplied by Atofina under the brand name KYNAR POWERFLEX® LBG 151 and another prior art battery cell was assembled in which both the positive and negative electrodes were prepared using the copolymer of PVDF and 10% HFP, supplied by Atofina under brand name KYNAR FLEX® 2800. In both cases, the total amount of polymer binder in the negative electrode composite was 10%. The comparative battery cells were also subjected to the same cycle life test, the result of which is depicted in FIG. 1. As illustrated, the cycle life of the lithium battery cell according to the present invention (in which the comonomer content is greater in the negative electrode than in the positive electrode) is significantly and unexpectedly better than the cycle life of the comparative battery cells having an equal amount of comonomer in the positive and negative electrodes.

### Example 2

A battery cell using the same copolymer binders as in Example 1 was prepared in accordance with the present invention, but using a total polymer binder amount in the negative electrode of only 8%. The positive electrode was prepared using the same amount of 12% as in Example 1. A comparative battery cell was also prepared using the copolymer binder of PVDF and 6% HFP as in Example 1, for both electrodes, similarly with an 8% total polymer binder amount in the negative electrode. The results of the cycle life tests are depicted in FIG. 2, in which the capacity retention at C/2 rate versus the number of cycles is plotted. As illustrated, the cycle life of the battery cell according to the present invention is significantly and unexpectedly better than the cycle life of the comparative battery cell prepared using an equal amount of HFP in each electrode, and the improvement in cycle life is not affected by the change in the total polymer amount in the negative electrode.

### Example 3

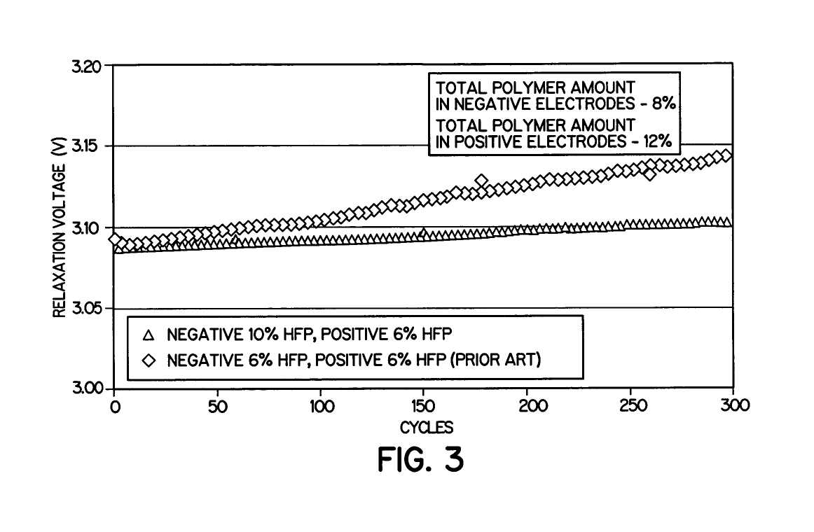

A battery cell of the present invention and a comparative battery cell, as set forth in Example 2, were tested to determine the improvement in the relaxation voltage, which reflects an improvement in the mass transport properties in the cell. Relaxation voltage is the cell voltage measured 10 minutes after the full cell discharge. An increase in the relaxation voltage during the cycle life reflects suppressed electron or lithium ion transport in the cell. As illustrated in FIG. 3, which plots the relaxation voltage versus the number of cycles in the life cycle test at 100% DOD and 55° C., the mass transport properties of the cell prepared according to the present invention are significantly and unexpectedly better during the cycle life than the transport properties of the comparative battery cell prepared using equal amounts of HFP in the copolymer of both electrodes.

In addition to the examples provided above, the following are exemplary battery cells according to the present invention. A negative electrode may be prepared using a copolymer binder of PVDF and 6% HFP, supplied by Atofina under the brand name KYNAR POWERFLEX® LBG 151, and the positive electrode is made using a copolymer binder of PVDF and 5% HFP, supplied by Atofina under the brand name KYNAR FLEX® 2850. A negative electrode is prepared using a copolymer binder of PVDF and 6% HFP, supplied by Atofina under the brand name KYNAR POWERFLEX® LBG 151, and the positive electrode is prepared using a homopolymer binder of PVDF, supplied by Atofina under the brand name KYNAR® 700. A negative electrode is prepared using a copolymer binder of PVDF and 5% HFP, supplied by Atofina under the brand name KYNAR FLEX® 2850, and the positive electrode is prepared using a homopolymer binder of PVDF, supplied by Atofina under the brand name KYNAR® 700. The following table summarizes the examples of the present invention explicitly provided herein.

| | Negative Electrode | | Positive Electrode | |
|---|---|---|---|---|
| | Primary | | Primary | |
| | Monomer | Comonomer | Monomer | Comonomer |
| Examples 1-3 | PVDF | 10% HFP | PVDF | 6% HFP |
| Example 4 | PVDF | 6% HFP | PVDF | 5% HFP |
| Example 5 | PVDF | 6% HFP | PVDF | 0% |
| Example 6 | PVDF | 5% HFP | PVDF | 0% |

In accordance with the above examples, an exemplary embodiment of the present invention includes a lithium battery cell in which the negative electrode is prepared using a copolymer binder of PVDF and 5-10 wt. % HFP and the positive electrode is prepared from a homopolymer or copolymer binder of PVDF and up to 6 wt. % HFP. However, the invention should not be limited to the specific examples enumerated herein.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, and illustrative examples shown and described. Accordingly, departures may be made from such details without departing from the scope or spirit of the general inventive concept.

1. A lithium polymer battery comprising a negative electrode and a positive electrode,
wherein the negative electrode comprises a copolymer of at least one first primary monomer and 1-30 wt. % of a first comonomer, and
wherein the positive electrode comprises at least one homopolymer of a second primary monomer or a copolymer of at least the second primary monomer and up to 25 wt. % of a second comonomer, and
wherein the amount of the first comonomer is greater than the amount of the second comonomer.

2. The battery of claim 1 wherein the negative electrode comprises 3-15 wt. % of the first comonomer and the positive electrode comprises 0-6 wt. % of the second comonomer.

3. The battery of claim 1 wherein the first and second comonomers are each hexafluoropropylene (HFP).

4. The battery of claim 3 wherein the first primary monomer in the negative electrode and the second primary monomer in the positive electrode are each of vinylidene fluoride (VDF).

5. The battery of claim 4 wherein the negative electrode comprises the copolymer of PVDF and 5-10 wt. % HFP, and the positive electrode comprises the homopolymer or the copolymer of PVDF and 0-6 wt. % HFP.

6. The battery of claim 4 further comprising at least one separator layer between the positive and negative electrodes, wherein the at least one separator layer comprises a homopolymer or copolymer of PVDF.

7. The battery of claim 1 further comprising a separator layer between the positive and negative electrodes comprising a copolymer of a third primary monomer, wherein the first, second and third primary monomers are identical.

8. The battery of claim 1 wherein the positive electrode consists essentially of a PVDF homopolymer.

9. The battery of claim 8 wherein the negative electrode comprises the copolymer of PVDF and 3-15 wt. % of the first comonomer.

10. The battery of claim 1 wherein the first and second primary monomers, after copolymerization or homopolymerization, are each selected from the group consisting of: polyvinylidene fluoride, polyvinylidene chloride fluoride, polyvinylidene chloride, polyvinyl chloride, polyvinylchloride acetates, polyacrylonitriles, polyfluoroethylenes, polyfluoropropylenes, polyolefins, acrylic acid modified polyethylene, maleic acid modified polyethylene, acrylic acid modified polypropylene, maleic acid modified polypropylene, polyvinyl alcohols, polyglycols, polyacetates, polyesters, polyacrylates, polycarbonates, polyethylene oxides, polypropylene oxides, polyacrylic acid esters, cellulose acetate, cellulose butyrate, nylons, polyurethanes, polyterephthalates, and polystyrenes.

11. The battery of claim 1 wherein the first and second comonomers are each selected from the group consisting of HFP and chlorotrifluoroethylene (CTFE).

12. A lithium polymer battery comprising a negative electrode and a positive electrode,
wherein the negative electrode comprises a polymer (POLYneg) that is a copolymer of a primary monomer (MONneg) and a comonomer (COMMneg), according to the formula COMMneg/(MONneg+COMMneg)=0.01 to 0.3, and
wherein the positive electrode comprises a polymer (POLYpos) that is a homopolymer of a primary monomer (MONpos) or a copolymer of MONpos and a comonomer (COMMpos), according to the formula COMMpos/(MONpos+COMMpos)=0 to 0.25, and
wherein COMMneg/(MONneg+COMMneg)>COMMpos/(MONpos+COMMpos).

13. The battery of claim 12 wherein COMMneg and COMMpos are each hexafluoropropylene (HFP).

14. The battery of claim 13 wherein MONneg and MONpos, after copolymerization or homopolymerization, are each polyvinylidene fluoride (PVDF).

15. The battery of claim 12 wherein POLYpos consists essentially of a PVDF homopolymer.

16. The battery of claim 12 wherein MONneg and MONpos, after copolymerization or homopolymerization, are each selected from the group consisting of: polyvinylidene fluoride, polyvinylidene chloride fluoride, polyvinylidene chloride, polyvinyl chloride, polyvinylchloride acetates, polyacrylonitriles, polyfluoroethylenes, polyfluoropropylenes, polyolefins, acrylic acid modified polyethylene, maleic acid modified polyethylene, acrylic acid modified polypropylene, maleic acid modified polypropylene, polyvinyl alcohols, polyglycols, polyacetates, polyesters, polyacrylates, polycarbonates, polyethylene oxides, polypropylene oxides, polyacrylic acid esters, cellulose acetate, cellulose butyrate, nylons, polyurethanes, polyterephthalates, and polystyrenes.

17. The battery of claim 16 wherein COMMneg and COMMpos are each selected from the group consisting of HFP and chlorotrifluoroethylene (CTFE).

18. A lithium polymer battery comprising a negative electrode and a positive electrode,
wherein the negative electrode comprises a polymer (POLYneg) that is a copolymer of a polyvinylidene fluoride (PVDFneg) and a comonomer (COMMneg), according to the formula COMMneg/(PDVFneg+COMMneg)=0.03 to 0.15, and
wherein the positive electrode comprises a polymer (POLYpos) that is a polyvinylidene fluoride (PVDFpos) homopolymer or a copolymer of PVDFpos and a comonomer (COMMpos), according to the formula COMMpos/(PDVFpos+COMMpos)=0 to 0.06 and
wherein COMMneg/(PDVFneg+COMMneg)>COMMpos/(PDVFpos+COMMpos).

19. The battery of claim 18 wherein COMMneg and COMMpos are each hexafluoropropylene (HFP).

20. The battery of claim 18 wherein POLYpos consists essentially of the PVDFpos homopolymer.
